(19) United States
(12) Patent Application Publication
(10) Pub. No.: US 2005/0229161 A1
(43) Pub. Date: Oct. 13, 2005

(54) Generic user interface testing framework with load-time libraries

(75) Inventors: Zhibin Wang, Woburn, MA (US); Dan Seeman, Novato, CA (US)

Correspondence Address: FLIESLER MEYER, LLP, FOUR EMBARCADERO CENTER, SUITE 400, SAN FRANCISCO, CA, 94111, US

(73) Assignee: BEA SYSTEMS, INC., San Jose, CA (US)

(21) Appl. No.: 10/814,563

(22) Filed: Mar. 31, 2004

(51) Int. Cl. G06F 9/44

(52) U.S. Cl. 717/125

(57) ABSTRACT

A system and method for providing a generic user interface testing framework, together with a mechanism such that libraries which are applicable to the desired application(s) can be qualified, and the test framework will load those libraries at execution time. With the ability to dynamically load only the desired libraries one is able to plug in new testing modules as needed, thus being able to accommodate new product qualification efforts with greater flexibility and efficiency.

### CROSS-REFERENCE TO RELATED APPLICATIONS

This application is related to copending applications SYSTEM AND METHOD FOR PROVIDING A GENERIC USER INTERFACE TESTING FRAMEWORK”, application Ser. No. ______, Inventors: Dan Seeman and Zhibin Wang, filed Mar. 31, 2004 (Atty. Docket No. BEAS-01512US0); and “GENERIC USER INTERFACE TESTING FRAMEWORK WITH RULES-BASED WIZARD”, application Ser. No. ______, Inventor: Zhibin Wang, filed Mar. 31, 2004 (Atty. Docket No. BEAS-01514US0), each of which applications are incorporated herein by reference.

### FIELD OF THE INVENTION

The invention is related generally to software development systems and particularly to a system and method for providing a generic user-interface testing framework.

### BACKGROUND

Modern computing systems often utilize large-scale and/or complex software systems. Typical examples of these software systems include operating systems, application servers, and other complex software applications. A key factor in developing and successfully marketing a complex software application is maintaining the quality of that application through a process of quality control. This typically includes tracking and fixing any inconsistencies, faults, or “bugs” that arise in the software code during the development process.

In most companies the quality control activity is the responsibility of a Quality Assurance (QA) team. Software fault analysis is often one of the more costly endeavors of the QA cycle of a product, both in terms of human and machine resources. Particularly on large and complex software products bugs can take hours or days to track down, often requiring 30%-40% of the QA teams efforts. Any system that can be used to speed up the bug identification and tracking process can lead to great improvements in development time and produce economic efficiencies for the company.

Graphical User Interfaces (GUI's), or User Interfaces (UI's) pose a special problem of software testing in that the QA testing of such a UI must mimic the types of interaction a user might make with the interface. Automated UI test development systems, suites and tools have been developed, including for example the WinRunner test automation system marketed by Mercury Interactive, Inc. However, the typical approach of such automated UI test development tools requires that the operator have knowledge not just of the test-tool-specific scripting language and environment, but also the specific features and idioms of the vendor-specific tool environment. The learning curve fort these UI testing tools can be significant, and is often of use solely with that one tool. (It is not uncommon for new users to spend 6 months or more to “ramp up” on a given tool, i.e. learn how to install it, use it, and write code to run it so as to produce workable, sustainable, reusable UI automation code). If another type of tool is to be used, the tester must again deal with the learning curve of the new tool. Furthermore, with the typical test development tool one needs to install the vendor specific software to use it, incurring both capital outlay and (local) resource costs. This initial capital outlay (i.e. the cost of the tool) typically cannot be recovered if the original tool is subsequently replaced with a new tool.

### SUMMARY

A system is herein described for providing a generic UI testing framework. The test framework, together with the systems and methods embodying the technology, maps the native test development language and environment into arbitrary languages and environments. This generic UI test framework insulates test developers from learning the tool-specific scripting language and environment.

In accordance with one embodiment, the UI test framework provides a set of function interfaces and implementations that cover all generic UI testing operations. New users need only map their testing logic to the supported library interface in order to use the test tool, or another test tool, without having to learn the details of the underlying test-tool-specific scripting language.

In accordance with another embodiment, the system includes a mechanism such that test developers can configure which libraries are applicable to the desired application(s) to be qualified and the test framework will only load those libraries at execution time. With the ability to dynamically load only the desired libraries one is able to “snap in” new testing modules as needed thus being able to accommodate new product qualification efforts with greater flexibility and efficiency. Test scripts can be developed into different functional modules. By developing modular libraries, we can develop a UI test framework to identify, load and use those libraries that are applicable to the applications under test.

In accordance with another embodiment, the system includes a rules based automation script generating engine that removes the necessity of test developers from learning the abstract environment, parameters and directives used to implement the UI test automation system. A user interface or wizard guides test developers through the various development stages. Upon completion, the test developer is left with a fully functional, end-to-end UI testing automation script.

### BRIEF DESCRIPTION OF THE FIGURES

FIG. 1 shows a logical diagram of a generic user-interface testing framework.

FIG. 2 shows a flowchart for using a generic user-interface testing framework.

FIG. 3 shows a logical diagram of dynamic load mechanism for use with a generic user-interface testing framework.

FIG. 4 shows a flowchart for using a dynamic load mechanism with a generic user-interface testing framework.

FIG. 5 shows the relationship between a wizard (or other editors) and the directives of test logic.

### DETAILED DESCRIPTION

Graphical User Interfaces (GUI's), or User Interfaces (UI's) pose a special problem of software testing in that the QA testing of such a UI must mimic the types of interaction a user might make with the interface. Automated UI test development systems, suites and tools have been developed, including for example the WinRunner test automation system marketed by Mercury Interactive, Inc. Building UI test cases traditionally involves using the UI test scripting language to construct the test logic of each test case. However, these UI test scripting languages are tied to specific test tools, and are traditionally difficult to learn and to use.

The inventors have reasoned that UI testing operations can be categorized into several dozens of common ones. Those UI testing operations, independent from test tools, are high-level logical abstractions of the actions that a user can perform on a particular UI. UI test cases (containing “directives”) can then be decoupled from the native scripting languages in such a way that UI test cases can be built using the descriptions of those common test operations. A UI test framework can supply the service of an interpretive engine that interprets the logic in the UI test cases and function libraries developed to support those generic testing operations in test-tool-specific scripting languages. In this way, UI test developers only need to write their automated UI tests in a tool-independent (or indeed a completely tool-absent) format ,such as in an XML, spreadsheet or a text form, to capture the test logic. In the test execution process, the UI framework's interpretive engine reads the directives of the test logic to drive tests using the underlying function libraries.

The directives of test logic can be captured in any format as long as the interpretive engine of the UI test framework is able to read the format correctly and to retrieve the information of the test logic. The directives can be created or edited using the appropriate editing tool for the chosen format. For example, if the directives are captured in the XML format then a text editor, an XML editor, or a wizard can be used to create or edit the file containing the directives; if the directives are captured in a spreadsheet, then a Microsoft Excel spreadsheet tool, or a similar spreadsheet program, can be used.

Because there are several dozens of well-defined logical UI testing operations, in accordance with one embodiment the UI test framework can provide a utility wizard that displays supported functions and guides test developers to pick and choose which functions they would like to use as the directives. The interpretive engine of the UI framework maps the directives into function libraries that are implemented in the test-tool-specific scripting language.

If, at some later date, the company or the test developers decide to use another test tool, then the test cases can be preserved since they only contain tool-independent test logic. Test framework developers can implement the same low-level functions in the new scripting language and the interpretive engine, thereby preserving and thus building on the value of all the work and experience that has been accomplished with the previous tool. Test developers familiar with the tool-independent environment are insulated from any change in the underlying tool. There is no need for them to even know the low level mechanism has been switched.

In accordance with other embodiments, kits and documentation may be provided for the UI test framework. New users only need to install the kit and follow the documentation to be able to utilize the advancement.

The test tool is only required for test execution. It is not required to build test cases, which contains tool-independent test logic. Users can choose whether or not to install “online” a core, tool-specific software. If they decide not to install the tool-specific software, users can create test cases “offline” at another machine, and then simply copy their tool-independent test cases to a central location where it will then be executed. This also saves cost on buying multiple instances of the vendor specific test tool.

Generic User Interface Test Framework

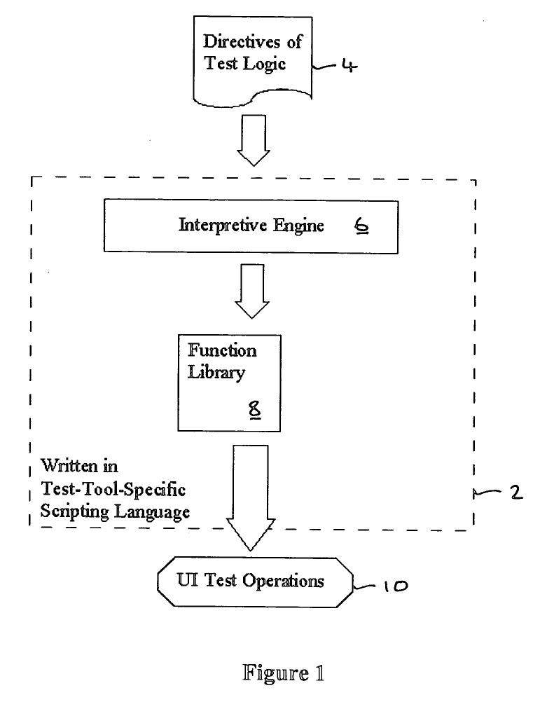

FIG. 1 shows a logical overview of a generic user-interface testing framework 2 in accordance with an embodiment of the invention. Test cases 4 contain the directives of tool-independent test logic and are written in a predefined format. The directives of test logic can be captured in any format as long as the interpretive engine of the UI test framework is developed and/or configured to read the format correctly and to retrieve the information of the test logic. The directives can be created or edited using the appropriate editing tool for the chosen format. For example, if the directives are captured in the XML format, a text editor, an XML editor, or a wizard can be used to create or edit the file containing the directives; if the directives are captured in the spreadsheet, then an Excel spreadsheet or similar tool can be used.

In accordance with one embodiment, an interpretive engine 6 parses the directives properly, and maps the directives to the underlying functions (in one embodiment through the use of libraries 8 or dynamic load libraries described in further detail below) to execute the UI action in the test-tool-specific environment 10. Both the interpretive engine and the supported function libraries are written in the tool-specific scripting language, for example WinRunner or any other tool language.

Developing a UI test case includes building directives that capture the logical test flow. A UI test developer is not required to know test-tool-specific scripting language or environment to build test cases. The test developer only needs to know how to capture the test logic using well-defined common testing operations (such as button-click, link-click, etc). An editing tool may be used to help create and/or edit the directives.

If a new tool is used to replace the existing tool, all of the directives 4 of test logic can be retained. Only the interpretive engine and the function libraries need to be re-implemented in the new scripting language. For example, switching from WinRunner as the testing tool, to a different testing tool, requires only changes to the interpretive engine and/or the function libraries. The directives themselves, which can be saved as test files, spreadsheets, or some other format, may be re-used.

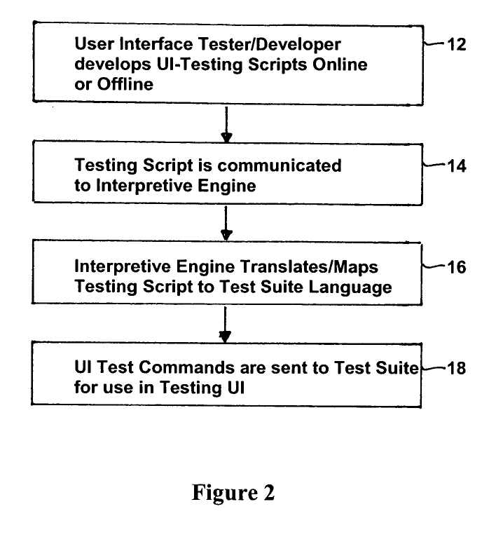

FIG. 2 shows a flowchart for a process of providing a generic user interface testing framework in accordance with an embodiment of the invention. As shown in FIG. 2, in step 12 the user interface tester/developer develops user interface testing scripts containing test directives. The scripts may be developed either online or offline. In an online environment, the scripts/directives can be fed directly to the test environment. In an offline environment, the scripts/directives can be saved and processed at a later time. In step 14, the testing script or directives are communicated to the interpretive engine. In step 16, the interpretive engine translates the script and/or directives and maps the generic commands therein into test suite-specific or test tool-specific language. In step 18, the test suite-specific language is used to drive the test suite in testing the build of the user interface.

Within any software corporation, most of the work involved in UI testing lies in building the test cases. Test cases can grow to thousands of lines of code (or more), while the number of actual common testing operations is limited. The amount of work to continuously build test cases far exceeds that of building an interpretive engine and the supported function libraries. In accordance with the present invention, the ability to preserve test cases during the test-tool switch provides exceptional value to reduce the cost of test development and maintenance.

Dynamic Load Mechanism

User interface applications can be distinctly different. For example, Internet browser based applications are visually and functionally different from the Java (swing/awt) UI applications. To conserve money, time and resources, companies often select one UI automation tool that can accommodate a variety of application types. This allows companies to share at least knowledge and training and in rare cases, tool-specific source code.

However, the aggregation of test-tool-specific source code for heterogeneous application types creates significant management overhead. The management overhead is often so onerous that companies often separate development efforts in total, resulting in duplicated staffing, efforts and source code. Reducing this duplication represents a significant savings for the company, not just in project management overhead, staffing, etc. but also in source code maintenance, flexibility and scalability.

An embodiment of the present invention addresses this issue by including within the generic UI test framework a mechanism such that test developers can configure which libraries are applicable to the desired application(s) to be qualified. The test framework will only load those desired libraries at execution time. With the ability to dynamically load only the desired libraries one is able to “snap in” new testing modules as needed, thus being able to accommodate new product qualification efforts with greater flexibility and efficiency.

The core of the dynamic load feature is to implement a well-defined contract system for executing loadable libraries. The higher layer system is able to load and execute contract compliant libraries. This system is similar to other dynamically loadable library systems. However the present system can be used to apply this logic to specific UI test tool products such that they can be used to qualify a wide variety of applications.

A key feature of the system is its flexibility. One is able to use the system to test a variety of applications. Moreover the system is generalized enough that one is not strictly confined to the implementation language of all the loadable libraries. As long as the loadable library entry point is contract compliant (and language specific), then subsequent libraries can be written in any language supported by the test-tool development language. For example, most UI test tool languages have an execution interface. One is perfectly free to use the execution interface to gain access to and use of any other development language.

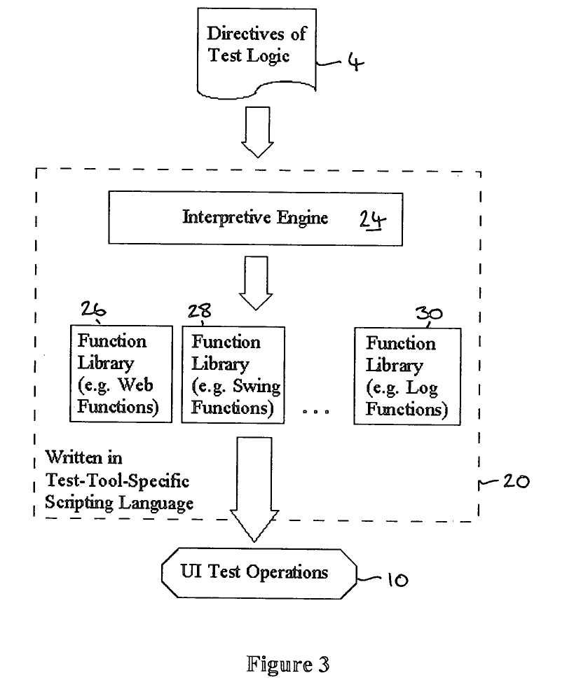

FIG. 3 shows a design for a system that includes a dynamic load library mechanism in accordance with an embodiment of the invention. As shown in FIG. 3, the system includes a generic testing framework 20 largely as described above, including an interpretive engine 24 that receives directives and translates them into UI test-tool-specific language 10. Functions are logically grouped into libraries (26-30), such as Web Functions 26, Swing Functions 28, Log Functions 30, etc. Additional libraries may be added as needed. The test framework can be configured to identify which libraries are to be loaded. Once it is configured, the test framework will only load those specified libraries at run time, which provide support for properly executing the tests. In this way, different UI tests will only load and use those libraries applicable to the tests. As new tool environments are used within a corporation, additional libraries can be included in the testing framework to provide support for those environments.

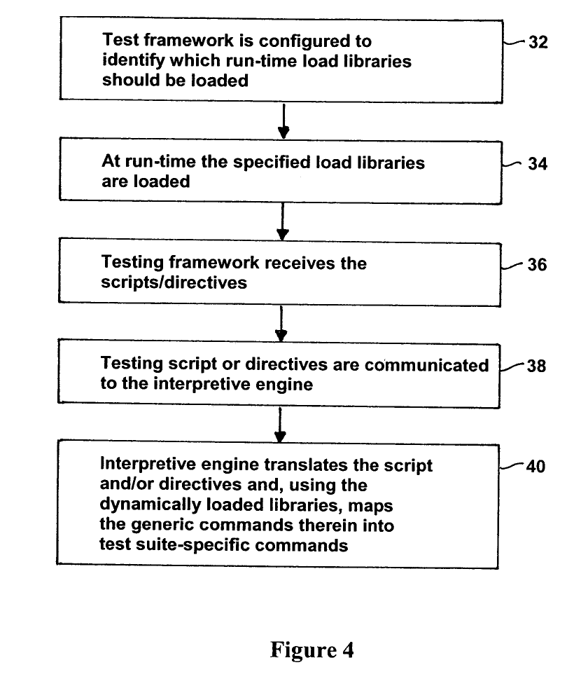

FIG. 4 shows a flowchart for a process of using a dynamic load mechanism with a generic user interface testing framework in accordance with an embodiment of the invention. As shown in FIG. 4, in step 32, the test framework is configured to identify which run-time load libraries should be loaded. In step 34, at run-time the specified load libraries are loaded. In step 36, the testing framework receives the scripts/directives, typically from a wizard, spreadsheet or other interface as described above. In step 38, the testing script or directives are communicated to the interpretive engine. In step 40, the interpretive engine translates the script and/or directives and, using the dynamically loaded libraries, maps the generic commands therein into test suite-specific commands for communications to the test suite or test tool.

User Interface Automation Wizard

After the developer has been abstracted away from writing test-tool-specific UI automation source code the problem of having to learn a test-driving language remains. A generic framework such as that described above is useful in mapping the test-tool-specific language into something more familiar to the target (test developing) audience. But even in the best circumstances the test developer must learn a new set of directives. The set of directives can be abstract and confusing. Furthermore, this knowledge is not transferable, as it is specific to the implementation environment. This task is equivalent to that of learning one company's internal (company, project or even group specific) Application Programming Interface (API) set. The language itself (XML for example) may be common, but the language formats, rules, commands and directives are typically unique.

An embodiment of the invention addresses this issue by including a rules-based automation script generating engine that removes the necessity of test developers from learning the abstract environment, parameters and directives used to implement the UI test automation system.

In accordance with an embodiment, a user interface or wizard guides test developers through the various development stages. Upon completion of all stages, the test developer is left with a fully functional, end-to-end UI testing automation script. This is not a replacement for a UI automation test-tool-specific action recorder. The source code produced by this engine is test tool “agnostic” and can be used (potentially) with any automation test tool. As long as the appropriate framework and libraries have been implemented in the test-tool-specific language, the source code produced by this rules engine can be used to drive it.

UI test scripting languages are difficult to learn and to use. Moreover, it is often easy to fall into the “use-once-and-trash-it” trap of UI automation tools. It is particularly easy to fall into this trap when using automation test-tool-specific action recorders. The test-tool-specific code produced by these action recorders is often relevant only to the specific parameters and environment(s) where the recorder was employed. This renders the generated code useless when it is copied to another location. This locks the developers into a perpetual state of writing and re-writing test automation code for similar or completely equivalent test scenarios. Companies hemorrhage significant capital and resources because of this perpetual cycle.

The solution to this problem is to first map the test-tool-specific language into one that is more familiar to the test developing staff, which is provided by te generic testing framework described above. A second layer to this solution is to provide a rules-based wizard that guides test developers through the code development sequence. The product of this engine is a standardized automation test that can be used with (potentially) any vendor specific UI automation tool. Implementation of this engine/wizard provides significant capital savings, day-to-day efficiency, learning curve reduction (even elimination) as well as test automation source code maintenance and flexibility.

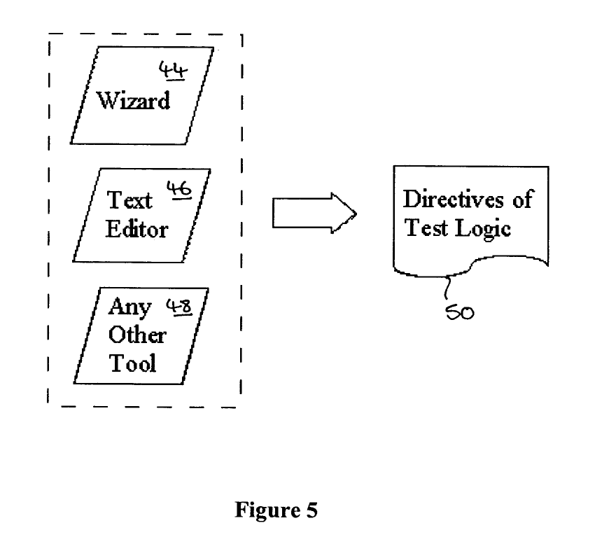

FIG. 5 shows the relationship between the wizard 44 (and other editors 46, 48) and the directives 50 of test logic. A rules-based wizard can be used to create or edit the document containing the directives. In accordance with an embodiment the wizard provides a set of UI testing operations. The wizard can then guide test developers to pick and choose any of the well-defined UI testing operations so as to build test cases. These test cases are then communicated to the testing framework as directives, and are processed as described in detail above.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, while the embodiment of the system is described in the context of a WebLogic system, and in combination or use with test development systems such as WinRunner, it will be evident thatthe framework provided may be used with other types of applications and systems, including other types of application servers, and with other types of test development systems. The embodiments were chosen and described in orderto best explain the principles of the invention and its practical application, thereby enabling others skilled in the art to understand the invention forvarious embodiments and with various modifications that are suited tothe particular use contemplated. It is intended that the scopeof the invention be defined by the following claims and their equivalence.

1. A system that provides a generic user interface testing framework, comprising:
an interpretive engine that receives and translates generic interface commands from a tester; and
a native library for mapping the generic interface commands to native language understood by a particular test software tool;
wherein the interpretive engine uses the native library to map the directives into tool-dependent codes that are then passed to the test software tool, and
wherein libraries can be loaded to support different test software suites and applications.

2. The system of claim 1 wherein the system includes the test software tool stored locally on the same computer or machine.

3. The system of claim 1 wherein the test software tool is stored at another computer or machine.

4. The system of claim 1 wherein the editor provides a graphical interface to allow the tester to enter said test commands.

5. The system of claim 1 wherein the editor communicates the test commands as a script of directives.

6. The system of claim 1 wherein the test commands can be created offline and subsequently communicated to the interpretive engine.

7. The system of claim 1 wherein the test software tool can be removed and replaced with another test software tool.

8. A method for providing a generic user interface testing framework, comprising the steps of:
allowing a tester to enter a number of generic test commands or directives via an editor or interface; and
translating, using an interpretive engine, the generic interface commands received from the tester, and mapping, using a native library, the generic commands to native language understood by a particular test software tool;
wherein the interpretive engine uses the native library to map the directives into tool-dependent codes that are then passed to the test software tool, and
wherein libraries can be loaded to support different test software suites and applications.

9. The method of claim 8 wherein the system includes the test software tool stored locally on the same computer or machine.

10. The method of claim 8 wherein the test software tool is stored at another computer or machine.

11. The method of claim 8 wherein the editor provides a graphical interface to allow the tester to enter said test commands.

12. The method of claim 8 wherein the editor communicates the test commands as a script of directives.

13. The method of claim 8 wherein the test commands can be created offline and subsequently communicated to the interpretive engine.

14. The method of claim 8 wherein the test software tool can be removed and replaced with another test software tool.

15. A computer readable medium including instructions stored thereon which when executed cause the computer to perform the steps of:
allowing a tester to enter a number of generic test commands or directives via an editor or interface; and
translating, using an interpretive engine, the generic interface commands from the tester, and mapping, using a native library, the generic commands to native language understood by a particular test software tool,
wherein the interpretive engine uses the native library to map the directives into tool-dependent codes that are then passed to the test software tool,
and wherein libraries can be loaded to support different test software suites and applications.

16. The computer readable medium of claim 15 wherein the system includes the test software tool stored locally on the same computer or machine.

17. The computer readable medium of claim 15 wherein the test software tool is stored at another computer or machine.

18. The computer readable medium of claim 15 wherein the editor provides a graphical interface to allow the tester to enter said test commands.

19. The computer readable medium of claim 15 wherein the editor communicates the test commands as a script of directives.

20. The computer readable medium of claim 15 wherein the test commands can be created offline and subsequently communicated to the interpretive engine.

21. The computer readable medium of claim 15 wherein the test software tool can be removed and replaced with another test software tool.
